(19) United States
(12) Patent Application Publication
(10) Pub. No.: US 2025/0329933 A1
(43) Pub. Date: Oct. 23, 2025

(54) Antenna Structure

(71) Applicant: SHENZHEN TCL DIGITAL TECHNOLOGY LTD., Shenzhen (CN)

(72) Inventors: Liuzhong Yin, Shenzhen (CN); Jiahui LUO, Shenzhen (CN)

(73) Assignee: SHENZHEN TCL DIGITAL TECHNOLOGY LTD., Shenzhen (CN)

(21) Appl. No.: 18/870,446

(22) PCT Filed: Feb. 27, 2023
(86) PCT No.: PCT/CN2023/078414

§ 371 Date: Nov. 28, 2024

(30) Foreign Application Priority Data
May 31, 2022 (CN) 202210611123.3

(51) Int. Cl. H01Q 9/06; H01Q 13/10; H01Q 21/00; H01Q 21/30

(52) U.S. Cl. CPC H01Q 9/065; H01Q 13/10; H01Q 21/0006; H01Q 21/30

(57) ABSTRACT

An antenna structure includes: a dielectric substrate, a first radiation sheet including a first portion and a second portion that is connected to the first portion, a second radiation sheet including a third portion and a fourth portion that is connected to the third portion, a gap formed between second radiation sheet and the first radiation sheet, and a feeder line including a first end for inputting an excitation signal, and a second end for feeding the excitation signal into the first radiation sheet and the second radiation sheet. The first portion, the third portion and gap form a slot antenna, and second portion and the fourth portion form a dipole antenna.

This application claims priority to Chinese Application No. 202210611123.3, entitled “Antenna structure”, filed on May 31, 2022. The entire disclosure of the above application is incorporated herein by reference.

### FIELD OF INVENTION

The present disclosure relates to the field of antenna technology, in particular to an antenna structure.

### BACKGROUND

At present, the beacon antenna mostly adopts the horn antenna. Because the high and low frequencies of the horn antenna are the same radiation port surface, the corresponding radiation pattern of the beamwidth is acute in the high frequency range and narrow beam significantly caused by the common port surface.

### SUMMARY

### Technical Problem

The beamwidth changes greatly as a change of frequency, resulting in a large change in the antenna gain, which makes the pattern of the directional radiation region of the antenna have poor broadband characteristics.

### Technical Solution

The purpose of the present disclosure is to provide an antenna structure in which the width of the main lobe of the pattern in the whole frequency band, i.e. the broadband characteristics of the pattern, can be basically the same through the coexistence of two radiation modes of the slot antenna and the dipole antenna.

In order to achieve the above purpose, the present disclosure provides the following technical scheme:

The embodiment of the present disclosure provides an antenna structure, comprising:
a dielectric substrate, comprising a first surface and a second surface opposite;
a first radiation sheet, arranged on the first surface, comprising a first part and a second part connected with the first part;
a second radiation sheet, arranged on the first surface, comprising a third part and a fourth part connected with the third part, where a gap is between the second radiation sheet and the first radiation sheet;
a feeder, arranged on the second surface, comprising a first end for inputting an excitation signal and a second end for feeding an excitation signal to the first radiation sheet and the second radiation sheet;
wherein the first part, the third part and the gap form a slot antenna, and the second part and the fourth part form a dipole antenna.

In some embodiments, the first part and the third part are symmetrical with the gap as an axis of symmetry to form a broadband balun structure.

In some embodiments, the gap expands in a direction away from the first part and the third part to form a horn-shaped notch.

In some embodiments, the first part comprises a first end and a second end, the second part comprises a first end and a second end, and the second end of the second part is connected with the first end of the first part.

In some embodiments, a width of the second end of the second part is greater than a width of the first end of the first part.

In some embodiments, a width of the first part gradually increases along the gap in the direction away from the second part.

In some embodiments, a width of the third part gradually increases along the gap in the direction away from the fourth part.

In some embodiments, a curved line is along an edge of one side of the first part away from the gap.

In some embodiments, the edge of one side away from the gap in the third part is an arc-shaped line.

In some embodiments, a length of a side of the second part away from the gap is less than a distance between the first end of the second part and the second end of the second part.

In some embodiments, a length of a side of the fourth part away from the gap is less than a distance between the first end of the fourth part and the second end of the fourth part.

In some embodiments, the feeder comprises a first segment and a second segment, and a via is arranged on the dielectric substrate; one end of the first segment corresponds to the first end of the feeder, the other end of the first segment is connected with one end of the second segment, and the other end of the second segment is connected with the first radiation sheet through the via.

In some embodiments, the first segment is parallel to the gap, a projection of the first segment on the first surface is located on the first radiation sheet, and the second segment is perpendicular to the gap and the projection on the first surface spans the gap.

In some embodiments, the feeder is partially short-circuited with the first radiation sheet of the first surface through the via.

In some embodiments, the feeder comprises a first segment, a second segment and a third segment; one end of the first segment corresponds to the first end of the feeder, one end of the second segment is connected with the other end of the first segment, the other end of the second segment is connected with one end of the third segment, the other end of the third segment is coupled with the first radiation sheet and the second radiation sheet, and the excitation signal is fed into the first radiation sheet and the second radiation sheet in the mode of coupling feeding.

In some embodiments, the first segment and the third segment are parallel to the gap, and a projection of the first segment on the first surface is located at the first radiation sheet, a projection of the third segment on the first surface is located at the second radiation sheet, and a projection of the second segment on the first surface spans the gap.

In some embodiments, the feeder comprises a microstrip feeder.

In some embodiments, the antenna structure further includes a reflector which is equally divided to form a first reflection area and a second reflection area. The dielectric substrate is perpendicular to the reflector, the first reflection area is close to the first surface, and the second reflection area is close to the second surface.

In some embodiments, a feeder port is arranged on the second reflective area, and the first end of the feeder is connected with the feeder port.

In some embodiments, the dielectric substrate is an FR4 dielectric plate.

### Advantageous Effect

In contrast to prior art, the present disclosure provides an antenna structure that includes a slot antenna and a dipole antenna. The antenna structure can switch from the working mode of the dipole antenna to the working mode of the slot antenna from low frequency to high frequency from, which can not only realize the wide frequency band, but also maintain the basic consistency of the pattern in the wide frequency band, so as to realize the broadband characteristics of the pattern and ensure that the antenna beam width is basically consistent.

### BRIEF DESCRIPTION OF DRAWINGS

FIG. 1 is a schematic diagram of the antenna structure according to an embodiment of the present disclosure.

FIG. 2 is a schematic diagram of the three-dimensional structure of the antenna structure according to an embodiment of the present disclosure.

FIG. 3 is a schematic diagram of the antenna structure according to an embodiment of the present disclosure.

FIG. 4 is a schematic diagram of the feeder of the antenna structure according to an embodiment of the present disclosure.

FIG. 5 illustrates the VSWR curve of the antenna structure according to an embodiment of the present disclosure.

FIG. 6, FIG. 7 and FIG. 8 depict the antenna structure at different frequency points for the present disclosure.

### DETAILED DESCRIPTION

The purpose of the present disclosure is to provide an antenna structure in which the width of the main lobe of the pattern in the whole frequency band can be basically the same, that is, the broadband characteristics of the pattern, through the coexistence of two radiation modes of the slot antenna and the dipole antenna.

In order to make the purpose, technical scheme and effect of the present disclosure clearer and more definite, the present disclosure is further described in detail below with reference to the accompanying drawings and embodiments. It should be understood that the specific embodiments described herein are used only to interpret the present disclosure and are not intended to qualify the present disclosure.

Referring to FIG. 1, an antenna structure includes a dielectric substrate 10, a first radiation sheet 11, a second radiation sheet 12 and a feeder 14. The dielectric substrate 10 includes a first surface and a second surface on opposite sides. The first radiation sheet 11 is arranged on the first surface, and the second radiation sheet 12 is arranged on the first surface. The first radiation sheet 11 and the second radiation sheet 12 are metal sheets. The first radiometer 11 comprises a first part A and a second part B connected to the first part A, and the second radiometer 12 comprises a third part C and a fourth part D connected to the third part C. There is a gap 13 between the first radiation sheet 11 and the second radiation sheet 12. The feeder 14 arranged on the second surface includes a first end for feeding excitation signal and a second end for outputting the excitation signal to the first radiation sheet 11 and the second radiation sheet 12. The first part A, the third part C and the gap 13 form a slot antenna, and the second part B and the fourth part D form a dipole antenna.

The antenna structure according to an embodiment of the present disclosure proposes the slot antenna and the dipole antenna with the two radiation modes, so that the antenna structure operates with two different radiation principles, i.e., the high frequency corresponds to the slot antenna radiation, and the low frequency corresponds to the dipole antenna radiation. The width of the main lobe of the pattern in the whole frequency band is basically the same, realizing the broadband characteristics of the pattern.

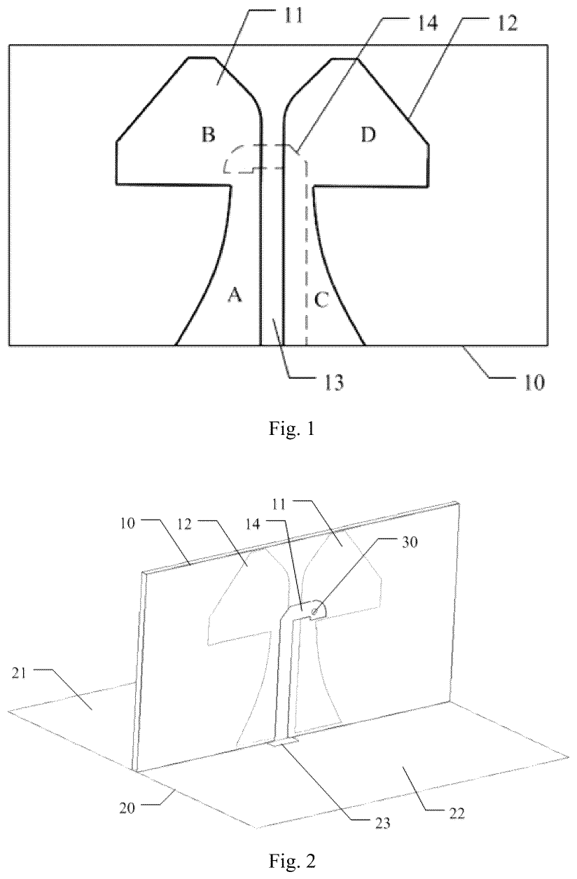

Please refer to FIG. 2, the antenna structure further includes a reflector 20 perpendicular to the dielectric substrate 10. The reflector 20 is equally divided into a first reflection area 21 and a second reflection area 22. The first reflection area 21 is close to the first surface, and the second reflection area 22 is close to the second surface. A feed port 23 is arranged on the second reflection area 22, and the first end of the feeder 14 is connected with the feed port 23. In this embodiment, the dielectric substrate 10 which is an FR4 dielectric plate with a thickness of 1.6 mm has advantages of low cost, high process precision, and good consistency.

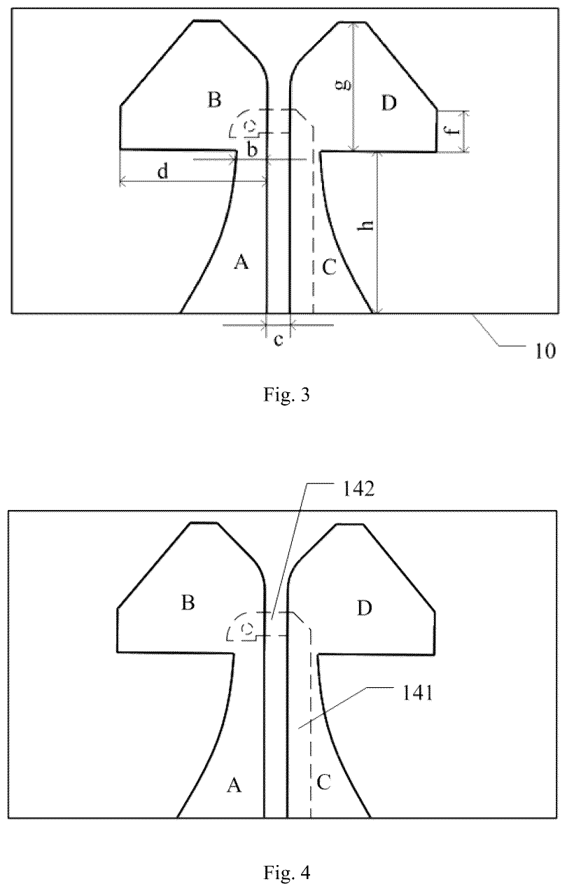

As illustrated in FIG. 3, in some embodiments, the first part A and the third part C are symmetrically arranged with the gap 13 as an axis of symmetry to form a broadband balun structure. A length h of the broadband balun structure along a direction parallel to the gap 13 on the first surface is a ¼ wavelength of a center frequency, where a width of the gap 13 can be 1.6 mm, that is, c in FIG. 3 is 1.6 mm. The third part C and the fourth part D are symmetrically arranged with the gap 13 as an axis of symmetry, that is the first radiation sheet 11 and the second radiation sheet 12 are symmetrically arranged with the gap 13 as the symmetrical axis. In this embodiment, the broadband balun structure is arranged to make the first radiation sheet 11 and the second radiation sheet 12 on both sides of the gap 13 fed balanced.

In some embodiments, the gap 13 has a horn-shaped notch in a direction away from the first part A and the third part C. In this embodiment, the second part B and the fourth part D close to the gap 13 are symmetrically oblique to form a horn-shaped notch at one end of the gap 13. When the antenna structure operates in the high frequency band, because of the horn-shaped notch, the antenna radiation is a slot antenna working mode instead of a dipole antenna working mode, so that the pattern of the antenna structure is basically unchanged under the broadband condition of low frequency to high frequency, and the pattern of the antenna structure when working in the high frequency band does not split. This ensures that the antenna beamwidth is basically the same.

Please refer also to FIG. 3, in some embodiments, the first part A comprises a first end and a second end, and the second part B comprises a first end and a second end. The second end of the second part B is connected to the first end of the first part A. A width d of the second end of the second part B is greater than a width b of the first end of the first part A, as shown in FIG. 3. The width of the first part A gradually increases along the gap 13 in the direction away from the second part B. The second part B and the fourth part D form the dipole antenna. The second part B and the fourth part D are equivalent to two antenna arms, and a length d of the antenna arm in the present embodiment can be 22 mm. The structure of the third part C and the structure of the first part A are symmetrically arranged with the gap 13 as the axis of symmetry. Similarly, the structure of the second part B and the structure of the fourth part D are symmetrically arranged with the gap 13 as the axis of symmetry. That is, a width of a junction between the first part A and the second part B and a width of a junction between of the third part C and the fourth part D are greatly narrowed. The width of the first part A and the third part C gradually increase along the gap 13 in the direction away from the second part B and the fourth part D. The edge of one side away from the gap 13 in the first part A and the third part C is an arc line. The minimum widths of the first part A and the third part C are determined based on the fact that the feeder 14 can transmit the TEM mode normally. The maximum widths of the first part A and the third part C are determined based on the pattern diagram of the actual antenna structure.

Further, in some embodiments, the length of the side of the second part B away from the gap 13 is shorter than the distance between the first end of the second part B and the second end of the second part B, i.e., f labeled in FIG. 3 is less than g. Similarly, since the second part B and the fourth part D are symmetrically arranged with the gap 13 as the axis of symmetry, the side of the fourth part D away from the gap 13 is shorter than the distance between the first end of the fourth part D and the second end of the fourth part D. Differing from an antenna arm of conventional dipole antenna, the second part B and the fourth part D in the side away from the gap 13 is obliquely cut, i.e. the outer side of the second part B and the fourth part D is chamfered, so that the resonant current is directed towards the reflector 20 at a certain inclination angle.

Please refer to FIG. 4. The feeder 14 comprises the first segment 141 and the second segment 142. The dielectric substrate 10 is provided with vias 30. The first segment 141 is arranged along the direction parallel to the second surface and the gap 13. One end of the first segment 141 is arranged on the edge of the dielectric substrate 10 and is connected with the feed port 23 on the reflector 20. A projection of one end of the first segment 141 on the first surface is located in the first part A, and a projection of the other end of the first segment 141 on the first surface is located in the second part B. One end of the first segment 141 corresponds to the first end of the feeder 14, the other end of the first segment 141 is connected with one end of the second segment 142. The other end of the second segment 142 is connected with the first radiation sheet 11 through via 30. The first segment 141 is parallel to the gap 13. A projection of the first segment 141 on the first surface is located on the first radiation sheet 11. The second segment 142 is perpendicular to the gap 13 and the projection on the first surface spans the gap 13. The feeder 14 in this embodiment is locally short-circuited with the first radiation sheet 11 on the first surface of the dielectric substrate 10 through a via 30 to form a strong feeder structure.

In some embodiments, via 30 is not set. The feeder comprises the first, second, and third segments. Similarly, in this embodiment, the first segment is arranged along the direction parallel to the gap 13 along the second surface. One end of the first segment is arranged on the edge of the dielectric substrate 10 and is connected with the feed port 23 on the reflector 20. The projection of one end of the first segment on the first surface is located in the first part A, and the projection of the other end of the first segment on the first surface is located in the second part B. One end of the first segment corresponds to the first end of the feeder. One end of the second segment is connected with the other end of the first segment, and the other end of the second segment is connected with one end of the third segment. The other end of the third segment is coupled with the first radiation sheet 11 and the second radiation sheet 12. The excitation signal is fed to the first radiation sheet 11 and the second radiation sheet 12 in the mode of coupling feeding. The first segment and the third segment are parallel to the gap 13. The projection of the first segment on the first surface is located at the first radiation sheet 11. The projection of the third segment on the first surface is located at the second radiation sheet 12. The projection of the second segment on the first surface spans the gap 13. That is, in this embodiment, because no via 30 is set on the dielectric substrate 10, the second segment of the feeder is extended to form the third segment. One end of the third segment is connected with the other end of the second segment, and the other end of the third segment extends a suitable length along the second surface to the position where the reflector 20 is located, so as to form of a coupled feeding structure.

It should be noted that the feeder in the present embodiment may be a microstrip feeder. In the design, it may also be other feeding modes, such as coaxial feeding, etc., and the present disclosure does not limit this.

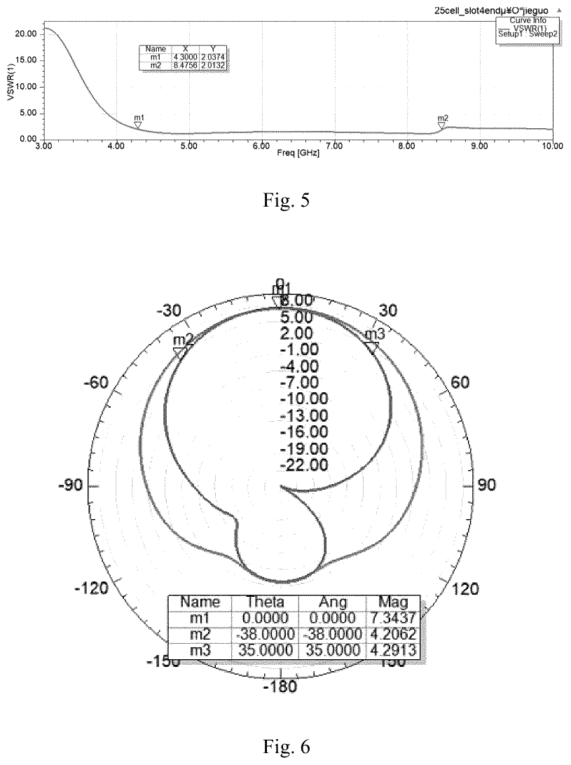

FIG. 5 illustrates a VSWR curve of the antenna structure in FIG. 2. The Voltage Standing Wave Ratio (VSWR) of the antenna structure is less than or equal to the impedance bandwidth of 4.3 GHZ-8.47 GHz in the full frequency band, the relative bandwidth is 65%, and the half-power width of the pattern in the frequency band is similar.

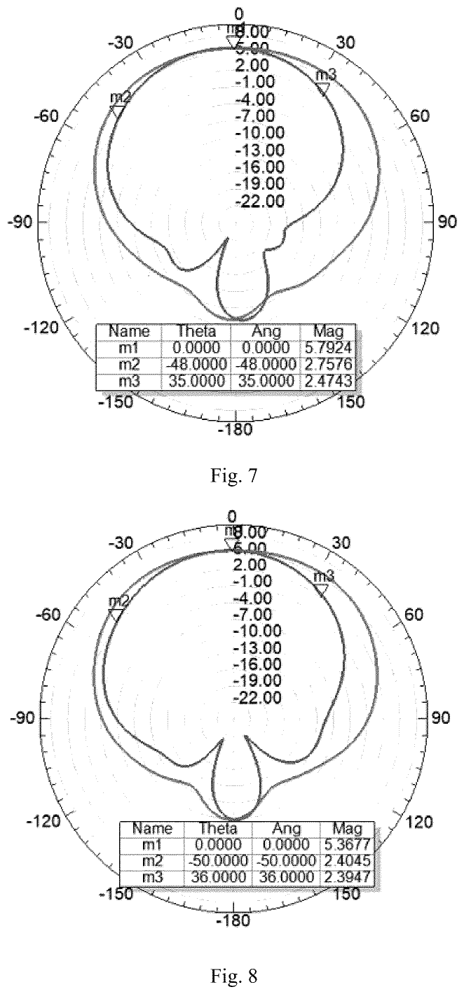

FIG. 6, FIG. 7 and FIG. 8 illustrate 2D patterns of radiation operating at 5.01 GHz, 6.5 GHz and 7.12 GHz, respectively, according to the antenna structure illustrated in FIG. 2. The inner curve represents the E plane and the outer curve represents the H plane. The H-plane and the E-plane are two reference planes that are orthogonal to each other, and the 3 DB beamwidth of the E-plane is less than 3 dB in the whole frequency band from 73°˜86°, and the normal ±35° range. The 3 dB beam width on the H-plane is about 180°.

The antenna structure according to the present disclosure includes a slot antenna and a dipole antenna. The antenna structure can transition from the working mode of the dipole antenna to the slot working mode from low frequency to high frequency, which can not only realize the ultra-wide frequency band, but also help to maintain the basic consistency of the pattern in the ultra-wide range.

In summary, the present disclosure provides an antenna structure includes a dielectric substrate comprising a first surface and a second surface opposite, a first radiation sheet arranged on the first surface and comprising a first part and a second part connected with the first part, a second radiation sheet arranged on the first surface and comprising a third part and a fourth part connected with the third part, and a feeder. A gap is between the second radiation sheet and the first radiation sheet. The feeder is arranged on the second surface and comprises a first end for inputting an excitation signal and a second end for feeding an excitation signal to the first radiation sheet and the second radiation sheet. The first part, the third part and the gap form a slot antenna, and the second part and the fourth part form a dipole antenna. The antenna structure can transition from the working mode of the dipole antenna to the working mode of the slot mode from the low frequency to high frequency, which can not only realize the ultra-wide frequency band, but also maintain the basic consistency of the pattern beamwidth in the wide range.

It is understood that, for a person skilled in the art, it may be equivalent to the technical solution of the present disclosure and its application conception to be replaced or changed, and all such changes or substitutions shall fall within the protection scope of the claims attached to the present disclosure.

1. An antenna structure, comprising:
a dielectric substrate, comprising a first surface and a second surface;
a first radiation sheet, arranged on the first surface, comprising a first part and a second part connected with the first part;
a second radiation sheet, arranged on the first surface, comprising a third part and a fourth part connected with the third part, wherein a gap is between the second radiation sheet and the first radiation sheet; and
a feeder, arranged on the second surface, comprising a first end for inputting an excitation signal and a second end for feeding an excitation signal to the first radiation sheet and the second radiation sheet;
wherein the first part, the third part and the gap form a slot antenna, and the second part and the fourth part form a dipole antenna.

2. The antenna structure of claim 1, wherein the first part and the third part are symmetrical with the gap as an axis of symmetry to form a broadband balun structure.

3. The antenna structure of claim 2, wherein the gap expands in a direction away from the first part and the third part to form a horn-shaped notch.

4. The antenna structure of claim 2, wherein the first part comprises a first end and a second end, the second part comprises a first end and a second end, and the second end of the second part is connected with the first end of the first part.

5. The antenna structure of claim 4, wherein a width of the second end of the second part is greater than a width of the first end of the first part.

6. The antenna structure of claim 4, wherein a width of the first part gradually increases along the gap in the direction away from the second part.

7. The antenna structure of claim 4, wherein a width of the third part gradually increases along the gap in the direction away from the fourth part.

8. The antenna structure of claim 6, wherein an edge of one side of the first part away from the gap is a curved line.

9. The antenna structure of claim 8, wherein the edge of one side away from the gap in the third part is an arc-shaped line.

10. The antenna structure of claim 1, wherein a length of a side of the second part away from the gap is less than a distance between the first end of the second part and the second end of the second part.

11. The antenna structure of claim 10, wherein a length of a side of the fourth part away from the gap is less than a distance between the first end of the fourth part and the second end of the fourth part.

12. The antenna structure of claim 1, wherein the feeder comprises a first segment and a second segment, and a via is arranged on the dielectric substrate; one end of the first segment corresponds to the first end of the feeder, the other end of the first segment is connected with one end of the second segment, and the other end of the second segment is connected with the first radiation sheet through the via.

13. The antenna structure of claim 12, wherein the first segment is parallel to the gap, a projection of the first segment on the first surface is located on the first radiation sheet, and the second segment is perpendicular to the gap and the projection on the first surface spans the gap.

14. The antenna structure of claim 13, wherein the feeder is partially short-circuited with the first radiation sheet of the first surface through the via.

15. The antenna structure of claim 1, wherein the feeder comprises a first segment, a second segment and a third segment; one end of the first segment corresponds to the first end of the feeder, one end of the second segment is connected with the other end of the first segment, the other end of the second segment is connected with one end of the third segment, the other end of the third segment is coupled with the first radiation sheet and the second radiation sheet, and the excitation signal is fed into the first radiation sheet and the second radiation sheet in the mode of coupling feeding.

16. The antenna structure of claim 15, wherein the first segment and the third segment are parallel to the gap, and a projection of the first segment on the first surface is located at the first radiation sheet, a projection of the third segment on the first surface is located at the second radiation sheet, and a projection of the second segment on the first surface spans the gap.

17. The antenna structure of claim 16, wherein the feeder comprises a microstrip feeder.

18. The antenna structure of claim 12- or 15, further comprising a reflector which is equally divided to form a first reflection area and a second reflection area, wherein the dielectric substrate is perpendicular to the reflector, the first reflection area is close to the first surface, and the second reflection area is close to the second surface.

19. The antenna structure of claim 17, wherein a feeder port is arranged on the second reflective area, and the first end of the feeder is connected with the feeder port.

20. The antenna structure of claim 19, wherein the dielectric substrate is an FR4 dielectric plate.
